(19) United States
(12) Patent Application Publication
(10) Pub. No.: US 2013/0099685 A1
(43) Pub. Date: Apr. 25, 2013

(54) Flexible Tubular Lighting System

(71) Applicant: Chengchun Zhang, Shenzhen City (CN)

(72) Inventor: Chengchun Zhang, Shenzhen City (CN)

(73) Assignee: Gemmy Industries Incorporated, Coppell, TX (US)

(21) Appl. No.: 13/653,557

(22) Filed: Oct. 17, 2012

Related U.S. Application Data
(60) Provisional application No. 61/550,215, filed on Oct. 21, 2011.

(51) Int. Cl. H05B 37/02

(52) U.S. Cl. 315/186

(57) ABSTRACT

A flexible tubular lighting system is disclosed for use with an AC power source and includes a flexible strip having a first end and a second end, an AC power plug at one end for connecting to the AC power source, and a plurality of LEDs spaced within the flexible strip. A control console connects to the AC power supply for converting a portion of the AC power supply to a DC power supply and connects to the LEDs for controlling the turning on and off of the LEDs. Power transmission cables connect from the first end to the second end for carrying the AC power the length of the flexible strip. An AC power end plug is also provided to allow mating with an AC power plug, or another flexible strip.

### CROSS-REFERENCE TO RELATED APPLICATIONS

This application is based on provisional application for patent, application Ser. No. 61/550,215, filed Oct. 21 2011 entitled Flexible Tubular Lighting System, incorporated by reference as if fully set forth herein.

### BACKGROUND OF THE INVENTION

1. Field of the Invention

The present invention relates to flexible LED lighting, and more particularly to a flexible tubular lighting system.

2. Description of Related Art

Lights have been used for decoration, advertizing, and general attention-getting for a long time. Lights have also been strung together, one after the other, for these purposes as well for many years. Of more recent, is a strand incasing a string of lights. The strand can be made of rigid or flexible material; the flexible material may be positioned in a variety of configurations.

U.S. Pat. No. 6,914,194 to Ben Fan discloses a flexible LED cable light having a flat insulation body, parallel wires in the body, and multiple flexible LEDs connected in parallel to the wires. From the AC power source, there is a power converter to covert the AC power to DC power to drive the LEDs. The disclosure claims that the flat body may be cut, and through the use of connectors, be connected, one strip to another.

Because of the known degradation in signal strength over distance when using DC power, the practical limitations of stringing multiple strands together are significant. Moreover, there is no disclosed ability to control turning on and off the lights in the strand in a predetermined pattern or patterns so as to enhance the visual impact of the strand.

### BRIEF SUMMARY OF THE INVENTION

A primary advantage of the present invention is to provide a flexible tubular lighting system that can be connected, one strand to another without appreciable loss in signal strength.

A related advantage of the present invention is to provide a flexible tubular lighting system that converts AC power to a DC power supply and maintains an AC power supply.

Another advantage of the present invention is to provide a flexible lighting system that controls turning on and off the LED lights In a pattern or patterns to enhance the visual impact of the light string.

In accordance with a preferred embodiment of the present invention, a flexible tubular lighting system for use with an AC power source, comprises a flexible strip having a first end and a second end; an AC power plug at one end for connecting to the AC power source; a plurality of LEDs spaced within the flexible strip; a control console connected to the AC power supply for converting a portion of the AC power supply to a DC power supply and connected to the LEDs for controlling the turning on and off of the LEDs; power transmission cables to connect from approximately the first end to approximately the second end for carrying the AC power the length of the flexible strip. An AC power end plug may be included to allow mating with an AC power plug or another flexible strip.

Other objects and advantages will become apparent from the following descriptions, taken in connection with the accompanying drawings, wherein, by way of illustration and example, an embodiment of the present invention is disclosed.

### BRIEF DESCRIPTION OF THE SEVERAL VIEWS OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a partial exploded and partial cut-away view of the flexible tubular lighting system in accordance with a preferred embodiment of the present invention.

FIG. 2 is a view similar to FIG. 1 showing the LEDs.

Figure is 3 a view showing decorative attachments to the flexible tubular lighting system of the present invention.

FIG. 4 is a schematic diagram illustrating the circuit connections between the LEDs.

FIG. 5 is a circuit diagram plan showing the various LED modules of the illustrated embodiment of the flexible tubular lighting system of the present invention.

### DETAILED DESCRIPTION OF THE INVENTION

Detailed descriptions of the preferred embodiments are provided herein. It is to be understood however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner.

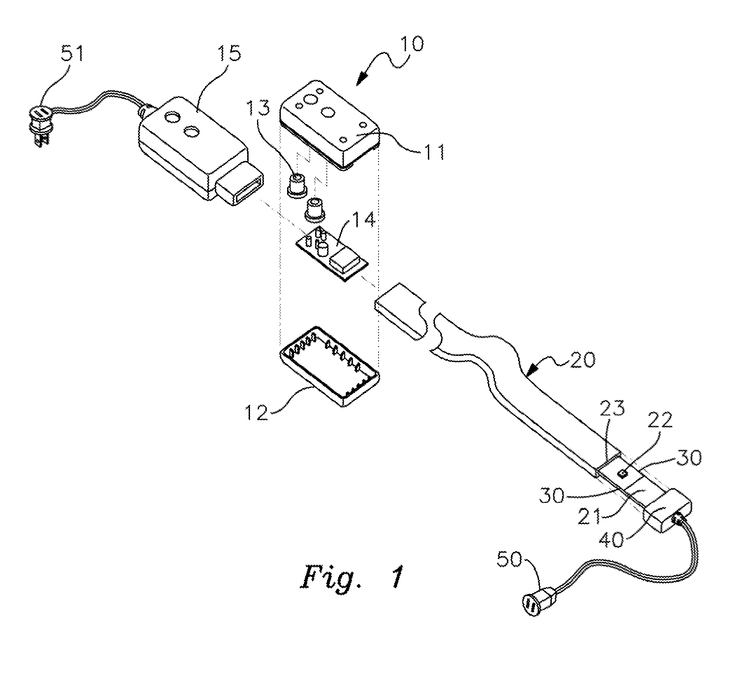

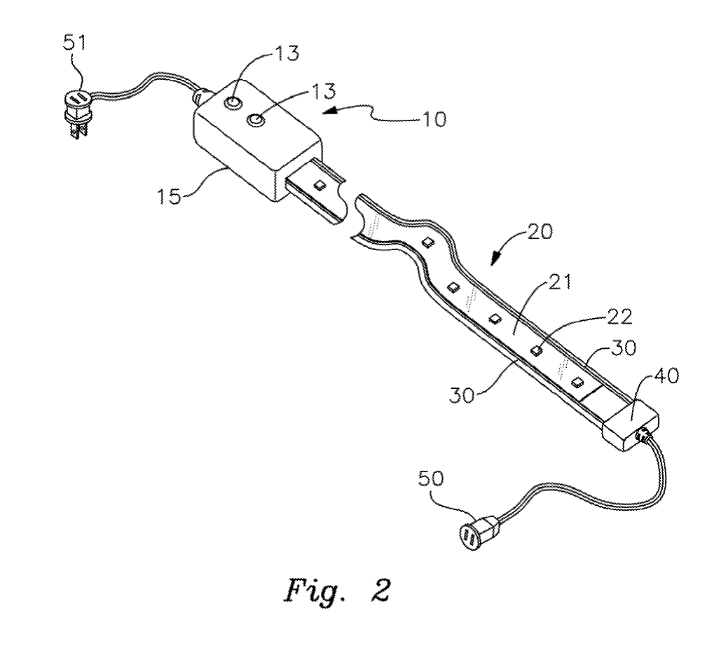

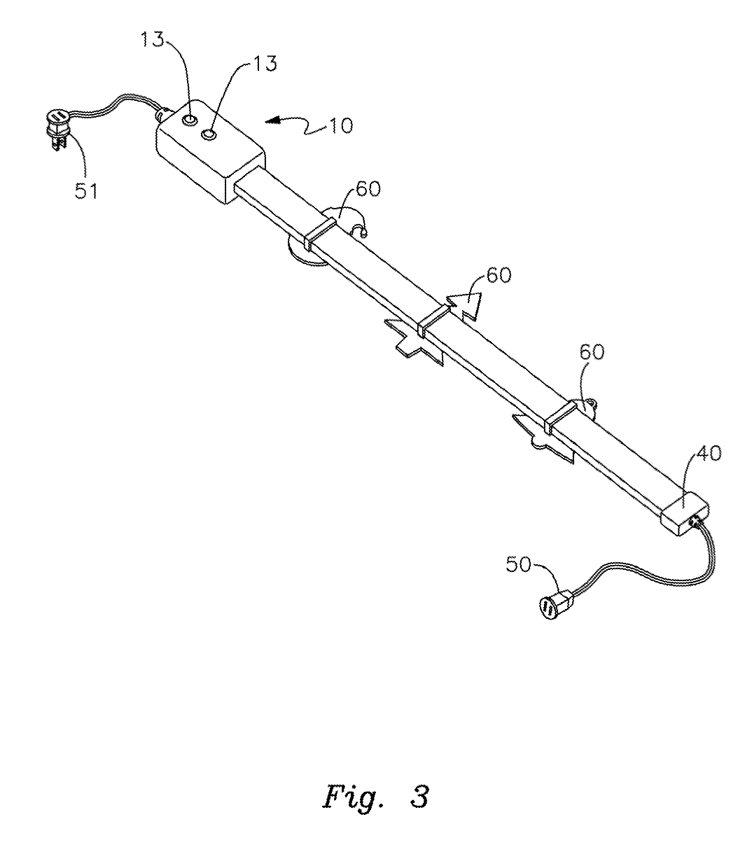

Referring first to FIG. 1 and FIG. 2, an illustrated embodiment of the instant invention is shown and includes a control console 10, a flexible tubular lamp 20, a group of power transmission cables 30, a waterproof plug 40 and an end plug 50.

Control console 10 includes upper casing 11 and lower casing 12. Control console 10 is connected to plug 51, and inside the console there is control circuit board 14. Power is supplied to control circuit board 14 through plug 51 and control key 13. Plug 51 is for connection to AC input voltage, and control console 10 converts AC input voltage into DC voltage to provide power to flexible tubular lamp 20. On the exterior surface of control console 10, waterproof plastic film 15 can be formed by secondary injection molding technology to provide better waterproofing and to prevent moisture from seeping into control console 10 to affect the electronic parts on control circuit board 14. In the example shown, control console 10 is pre-set with a control program, which can output control signal by control circuit board 14 to flexible tubular lamp 20 without requiting external control. On the surface of control console 10, there is control key 13. The user can operate control key to control the method of on/off patter and changes of the flexible tubular lamps.

Control console 10 connected to one end of the flexible tubular lamp 20 includes flexible circuit board 21. On flexible circuit board 21, there are multiple numbers of LED modules 22 and a transparent protective cover 23 covering flexible circuit board 21. Transparent protective cover 23 can be a transparent protective cover or a translucent protective cover, among other protective covers. The LED module 22 can be an SMD LED module.

Power transmission cables 30 are covered inside transparent protective cover 23, and connected to control console 10 to transmit AC input voltage to end plug 50.

Waterproof plug 40 is connected to the other end of flexible tubular lamp 20 to provide waterproofing and to prevent external moisture and other particles from getting inside flexible tubular lamp 20. Similar to the description above regarding control console 10, on the exterior surface of waterproof plug 40, a waterproof plastic film can be formed again by secondary injection molding technology to yield better waterproofing results.

End plug 50 is connected to power supply through one end of flexible tubular lamp 20 to the group of power transmission cables 30. End plug 50 can be connected to another independent unit of decorative tubular lamps, increasing the number of decorative tubular lamps connected together to elongate the length of illumination.

Referring next to FIG. 3, a number of decoration cards 60 can be placed on flexible tubular lamp 20 to add more uses to the lighting system and to enhance its decorative function. Decoration cards 60, with different themes and shapes, can be used according to different occasions. For example, for Christmas decoration, decoration cards 60 in the shapes of a snowman, ringing bells. Christmas tree, etc. can be used to show the festive season.

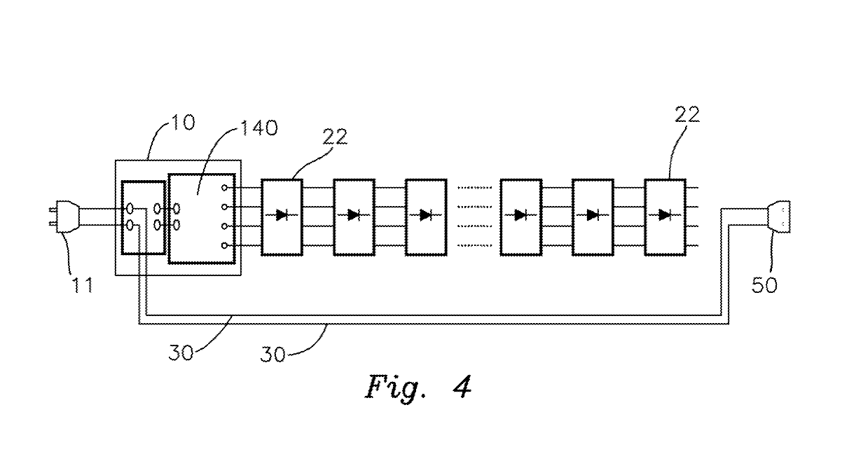

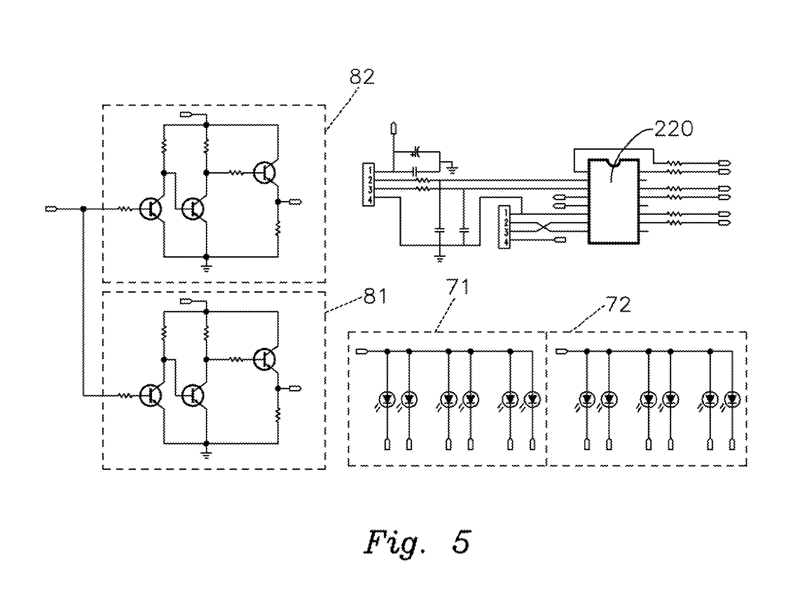

Referring next to FIG. 4 and FIG. 5, on control circuit board 14 in control console 10, there is master control chip 140 In each of LED modules 22, there is slave control chip 220. Through the circuit on the surface of flexible circuit board 21, master control chip 140 and slave control chips 220 form a serial connection. Master control chip 140 has a data output pin DATA and a clock signal pin CLK. Each slave control chip 220 has a data input pin DIN, a data output pin DOUT, a selection pin SEL, multiple numbers of LED control pin R(ed)1, G(reen)1, B(lue)1 R2, G2 B2. R3, G3, B3, a clock signal input pin CIN and a clock signal output pin COUT.

The data output pin DATA of master control chip 140 is connected to the data input pin DIN of the first LED module 22. The data output pin DOUT of the first LED module 22 is connected to the data input pin DIN of the next LED module 22. A serial connection can be formed in this fashion. Therefore, the pre-set control program in master control chip 140 can be output to subsequent LED module 22 to make LED module 22 illuminate and change colors to form various diagrams and color combinations. Master control chip 140 takes a sampling of the AC input voltage frequency, e.g. 60 Hz, to be the standard clock signal. The standard clock signal is output from the clock signal pin CLK to the clock signal input pin CIN of first LED module 22. Clock signal output pin COUT of first LED module 22 is then connected to clock signal input pin CIN of the next LED module 22. As such, a serial connection can be formed. As various LED modules 22 can receive the same standard clock signal, therefore effects requiring simultaneous changes can be achieved.

Several numbers of LED can be placed inside each LED module 22 according to the number of LED control pins R1, G1, B1, R2, G2, B2, R3, G3, B3: but can use only part of the LED control pins as required, instead of using all of them. The LEDs can be of the same color or multiple colors, and can be separated into different groups and driven according to different time sequence to produce a greater variety of decorative illumination effects. In the illustrated embodiment, a number of LEDs are separated into Primary LED group 71 and Secondary LED group 72. Primary LED group 71 and Secondary LED group 72 are respectively connected to primary driver circuit 81 and secondary driver circuit 82.

Primary and secondary driver circuits 81 and 82 are connected to the selection pin SEL of slave control chip 220, and can produce two control signals of varying time sequence based on the signal of selection pin SEL. The two control signals are output to Primary LE D group 71 and Secondary LED group 72 via the two signal output pin SEL 135 and SEL 246 respectively. As Primary LED group 71 is connected to slave control chip 220, a part of the LED control pins and the primary driver circuit 81; while Secondary LED group 72 is connected to slave control chip 220, the other part of the LED control pins and secondary driver circuit 82. Therefore, Primary LED group and Secondary LED group 72 can be illuminated to produce different decorative lighting effects as controlled by slave control chip 220. More than two groups can be implemented in a similar fashion, as is well known in the art.

All of the compositions and/or methods disclosed and claimed herein can be made and executed without undue experimentation in light of the present disclosure. While the compositions and methods of this invention have been described in terms of various embodiments, it will be apparent to those of skill in the art that other variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the claims.

What is claimed is:

1. A flexible tubular lighting system for use with an AC power source, the lighting system comprising:
a flexible strip having a first end and a second end;
an AC power plug at one end for connecting to the AC power source;
a plurality of LEDs spaced within the flexible strip;
a control console connected to the AC power supply for converting a portion of the AC power supply to a DC power supply and connected to the LEDs for controlling the turning on and off of the LEDs;
power transmission cables to connect from approximately the first end to approximately the second end for carrying the AC power the length of the flexible strip; and
an AC power end plug to allow mating with an AC power plug or another flexible strip.

2. A flexible tubular lighting system as claimed in claim 1 wherein the control console includes a circuit board having a control program to control the LEDs.

3. A flexible tubular lighting system as claimed in claim 1 wherein the control console includes a plurality of programmed on/off LED patterns and one or more control keys to select one of the plurality of programmed patterns.

4. A flexible tubular lighting system as claimed in claim 1 further comprising:
One or more decoration cards attachable to the flexible strip of LEDs.

5. A flexible tubular lighting system as claimed in claim 1 wherein the control console includes a master control chip and a slave control chip in serial connection.

6. A flexible tubular lighting system as claimed in claim 1 wherein the plurality of LEDs can be separated into groups for a variety of decorative illumination effects.

7. A flexible tubular lighting system for use with an AC power source, the lighting system comprising:
a flexible strip having a first end and a second end;
an AC power plug at one end for connecting to the AC power source;
a plurality of LEDs spaced within the flexible strip;
a control console connected to the AC power supply for converting a portion of the AC power supply to a DC power supply and connected to the LEDs for controlling the turning on and off of the LEDs; and
power transmission cables to connect from approximately the first end to approximately the second end for carrying the AC power the length of the flexible strip.

8. A flexible tubular lighting system as claimed in claim 7 further comprising:
an AC power end plug to allow mating with an AC power plug, or another flexible strip

9. A flexible tubular lighting system as claimed in claim 7 wherein the control console includes a circuit board having a control program to control the LEDs.

10. A flexible tubular lighting system as claimed in claim 7 wherein the control console includes a plurality of programmed on/off LED patterns and one or more control keys to select one of the plurality of programmed patterns.

11. A flexible tubular lighting system as claimed in claim 7 further comprising:
One or more decoration cards attachable to the flexible strip of LEDs.

12. A flexible tubular lighting system as claimed in claim 7 wherein the control console includes a master control chip and a slave control chip in serial connection.

13. A flexible tubular lighting system s claimed in claim 7 wherein the plurality of LEDs can be separated into groups for a variety of decorative illumination effects.
